(19) United States
(12) Patent Application Publication
(10) Pub. No.: US 2002/0160157 A1
(43) Pub. Date: Oct. 31, 2002

(54) Tack cloth and associated manufacturing process

(75) Inventor: David R. Smith, Peoria, IL (US)

Correspondence Address: Kevin M. Kercher, Husch & Eppenberger, LLC, Suite 1400, 401 Main Street, Peoria, IL, 61602-1241, US

(73) Assignee: Textus USA, Inc.

(21) Appl. No.: 09/845,617

(22) Filed: Apr. 30, 2001

(51) Int. Cl. B32B 5/02; B05D 3/12; B32B 27/04; B32B 9/04; D03D 15/00

(52) U.S. Cl. 428/193; 428/192; 442/153; 442/164; 442/197; 427/430.1; 427/439; 427/434.2; 427/289

(57) ABSTRACT

A method for manufacturing tack cloth including weaving fibers into a textile fabric with a loom, impregnating the textile fabric with a resin, and cutting the resin impregnated textile fabric to create at least one serrated edge. The preferred type of serrations are triangular and the preferred resin is polybutene. The serrating of the resin impregnated tack cloth provides superior thread retention capabilities.

### TECHNICAL FIELD

This invention relates generally to a tack cloth having superior structural properties, and more particularly, to a tack cloth having superior thread retention capabilities.

### BACKGROUND OF THE INVENTION

There are a wide variety of uses of tack cloth. Tack cloths are impregnated with a chemical formulation to pick-up and hold loose foreign particles. Tack cloths are typically used after sanding and between coats of either paint, stain, varnish solutions among numerous other types of chemical treatments to assure a smooth and blemish-free surface. The primary use of tack cloths is in the automobile industry to provide a high quality surface finished and prevent small pit holes from forming after painting. Tack cloths are also used in aerospace, computer and precision instrument applications where a dust free environment is needed. Furniture manufacturers use tack cloths in the refinishing business when the cleanliness and smoothness of the furniture's finish is important. Tack cloths are also used in hospitals to clean patient beds, wheel chairs, patient rooms, ventilators and anything else where contamination is a problem. The military uses tack cloths to prevent dust from collecting in their weapons and machinery. Dust in weapons and machinery can cause misfires and other significant problems. Tack cloths can be used at the home or office for cleaning and dusting.

One significant problem with tack cloths is that the threads come loose and break free from the cloth. This is a significant problem since it destroys the accuracy of the cleaning process by having these loose threads sticking out from the cloth. One of the advantages of tack cloth is the ability to remove dirt and dust from fine areas. With threads coming loose and either extending out of the cloth or falling away from the cloth, this precision cleaning process simply cannot occur.

The present invention is directed to overcoming one or more of the problems set forth above.

### SUMMARY OF THE INVENTION

In one aspect of this invention, a tack cloth is disclosed. The tack cloth includes a woven fabric impregnated with resin, wherein at least one edge of the woven fabric is serrated.

In another aspect of this invention, a method for manufacturing tack cloth is disclosed. The method includes weaving fibers into a textile fabric with a loom, impregnating the textile fabric with a resin, and cutting the resin impregnated textile fabric with shears to create at least one serrated edge on the textile fabric.

### BRIEF DESCRIPTION OF THE DRAWINGS

For a better understanding of the present invention, reference may be made to the accompanying drawings in which:

FIG. 1 is a schematic side view of a loom for weaving tack cloth fabric;

FIG. 2 is a schematic side view of a resin bath utilized in saturating the tack cloth fabric;

FIG. 3 is a side view of pinking shears; and

FIG. 4 is a top view of a piece of tack cloth processed in accordance with the present invention.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details.

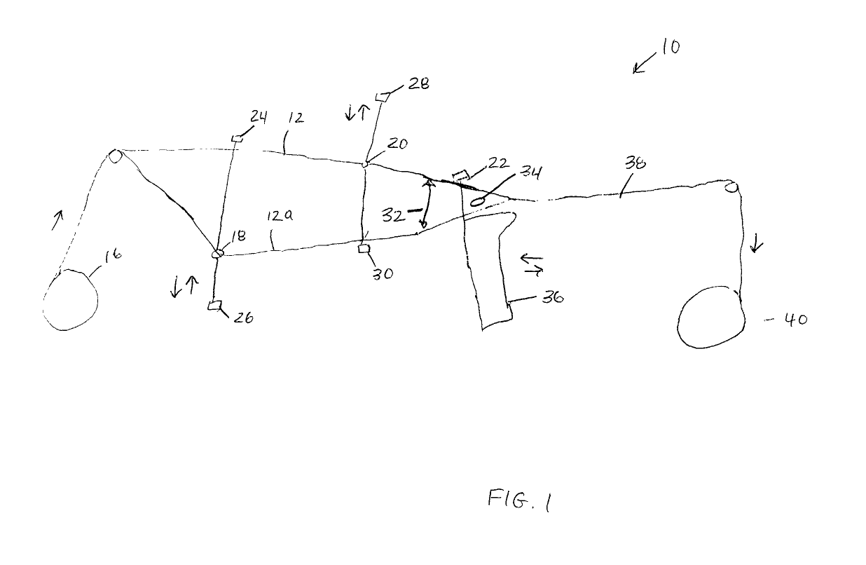

Referring now to the drawings, and initially to FIG. 1, which illustrates a loom utilized for turning threads into a tack cloth is denoted generally by reference numeral 10. This is accomplished through interlacing a series of vertical, parallel threads otherwise know as the “warp” 12 and 12a with a series of horizontal, parallel threads otherwise known as the “filling” (not shown).

For example, warp thread 12, coming from a loom beam 16, passes through a first heddle 20 that is raised. The heddle 20 is a wire or strip of steel that has an eye for receiving the warp thread 12. The heddle 20 is raised by means of an upper harness 28 or lowered by means of the lower harness 30. The adjacent warp thread 12a, coming from the loom beam 16, passes through a second heddle 18 that is lowered. The heddle 18, like heddle 20, is a wire or strip of steel that has an eye for receiving the warp thread 12a. The heddle 18 is raised by means of an upper harness 24 or lowered by means of the lower harness 26.

The fact that all of the adjacent warp threads are either up or down, forms a shed 32 between these adjacent warp threads, e.g., warp threads 12 and 12a. There is a shuttle 34 or similar device that shoots across the shed individually carrying a single filling thread on each trip. Optimally, air can be used instead of a physically shuttle 34. Water or other fluid can be utilized to transport the filling thread. The filling thread is then cut-off by utilizing heated wires or other types of thread cutting devices. Each filing thread is then shoved against adjacent filling threads by means of reed 22. The reed 22 is a comb-like device that separates the warp yarns, e.g. 12, 12a and also beats each succeeding filing thread against previously beaten filling threads to form a woven cloth fabric 38. The reed 22 usually includes a top rib and a bottom rib of wood where metal strips or wires (not shown) are set. The warp threads are drawn through the space between adjacent strips or wires. The lay 36 is secured to a bottom portion of the reed 22 for providing the pivoting motion. The woven cloth fabric 38 is then taken-up by a cloth beam 40. The width of the woven cloth fabric 38 can vary with the preferred width being thirty-six (36) inches (91.44 centimeters).

A typical loom for weaving is disclosed in U.S. Pat. No. 6,209,588, that issued Apr. 3, 2001, which is incorporated herein by reference.

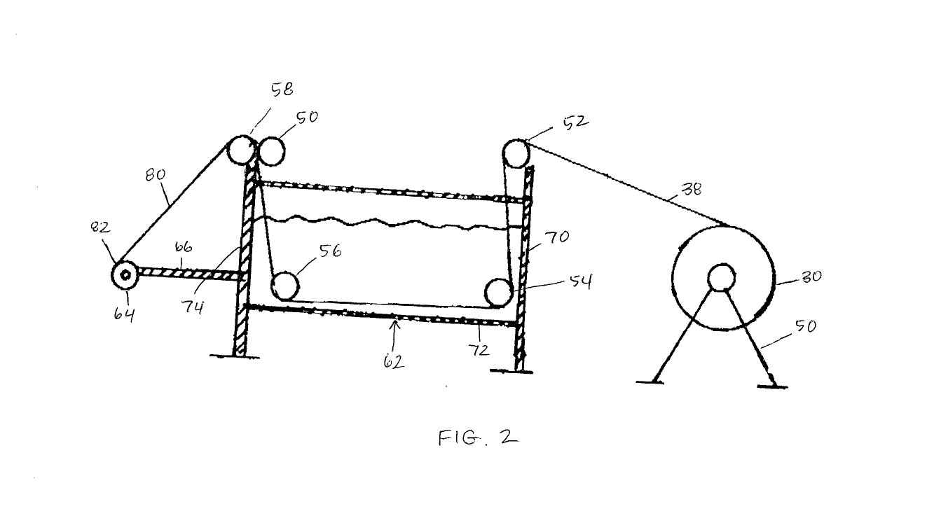

Referring now to FIG. 2, the woven cloth fabric 38 is taken off from a take-off stand 50. The woven cloth fabric 38 passes over a first guide roller 52, attached to first side wall 70 and then drops down in a substantially vertical direction into a chemical tank that is generally indicated by numeral 62. The woven cloth fabric 38 is then returned to travelling in a substantially horizontal direction by a second guide roller 54 along the bottom 72 of the chemical tank 62. The woven cloth fabric 38 is then directed vertically upward near the second side wall 74 by a third guide roller 56. The second side wall 74 is located opposite the first side wall 70. The woven cloth fabric 38 than passes through a pair of pinch rollers 58 and 60, respectively that squeeze the excess chemical out of the woven cloth fabric 38. The chemically treated woven cloth fabric 80 is then taken up by a wind-up roll 82. As an illustrative example, there are approximately One Thousand (1,000) yarns wound on the wind-up roll 82. This wind-up roll 82 may be attached to the chemical tank 62 by member 66, however, this is not necessary.

The preferred chemical for use in the chemical tank 62 is polybutene resin, where the woven cloth fabric is saturated or impregnated with this resin. This polybutene resin is originally in a wax-like state. It has to be heated to 300 degrees Fahrenheit (148.9 degrees Celsius) to melt into a liquid state. The preferred method of achieving this is to put a band heater around a forty-five gallon (170.34 liter) drum of this product. The polybutene resin is then pumped out of the drum. The chemical tank should optimally be maintained at 300 degrees Fahrenheit (148.9 degrees Celsius) to maintain the polybutene resin in this molten state. The amount of tack resin applied to the chemically-treated woven cloth fabric 80 is dependent on the temperature of the resin, the pressure applied by the pinch rollers 58 and 60 and the speed of the woven cloth fabric 38 as it traverses the chemical tank 62.

There are numerous methods for heating the chemical tank 62. A typical method for heating a chemical tank is disclosed in U.S. Pat. No. 5,494,491, which issued Feb. 27, 1996, which is incorporated herein by reference. A textile treatment tank is disclosed in U.S. Pat. No. 5,193,362, which issued Mar. 16, 1993, which is incorporated herein by reference.

The preferred type of woven cloth fabric 38 is cheesecloth. This can be either One Hundred Percent (100%) cotton, One Hundred Percent (100%) polyester or some blended combination in between. If a blend is utilized, the preferred percentage of polyester is at least fifty-five percent (55%) and optimally sixty-five percent (65%). As previously stated, the preferred width of the woven cloth fabric 38 is thirty-six (36) inches (91.44 centimeters). The denier is preferably 32 with the mesh count preferably being 28 by 24.

A nonlimiting and illustrative example is that this chemically treated woven cloth fabric 80 is folded into four (4) plies of eight (8) inches (20.32 centimeters) each. This chemically treated woven cloth fabric 80 can be cut into pieces. Eighteen inches (45.72 centimeters) in length is an illustrative example of a customer-requested size. A single ply polyester fabric can also be used where the edges are preferably sewn or selvedge edges and not cut or slit.

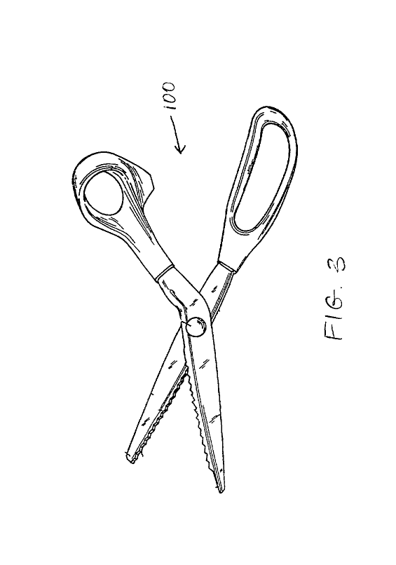

As shown in FIG. 3, the next step that completely flies in the face of conventional wisdom is to apply pinking shears 100 to the chemically-treated woven cloth fabric 80 after it has been rolled-out. The chemical resin makes the woven cloth fabric 80 sticky and extremely hard to handle. A typical pinking shear 100 is disclosed in U.S. Pat. No. 4,406,063, that issued Sep. 27, 1983, which is incorporated herein by reference.

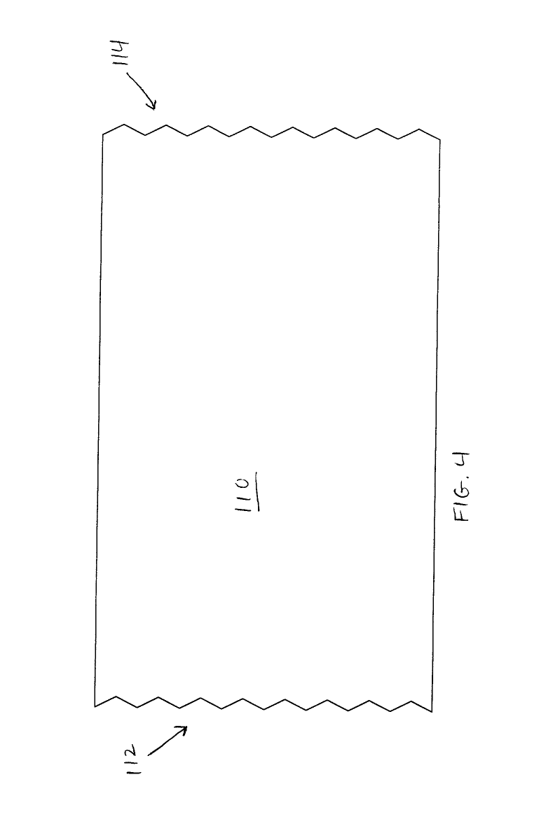

Referring now to FIG. 4, the sides of the chemically-treated woven cloth fabric 80 fabric, are serrated, which results in keeping the threads of the tack cloth 110 intact. These serrations located on a first side 112 and a second side 114 are substantially triangular. However, rectangular or circular shaped edges would also suffice to a lesser degree.

Industrial Applicability

The present invention is advantageously applicable in creating tack cloth that retains threads by defying conventional wisdom by applying pinking shears to the tack cloth after it has already been saturated in resin. This is at a point where the cloth is very sticky and extremely difficult to handle. By applying the pinking shears beforehand, you run the risk of dislodging threads prior to having them secured by the resin. This invention solves a very significant problem of thread displacement by applying a technique that prior patents and publications teach away from since these patents and publications instruct a person skilled in the art not to perform manual operations, e.g. cutting, on sticky, hard to handle textile materials at this step of a textile treatment process.

Other aspects, objects and advantages of the present invention can be obtained from a study of the drawings, the disclosure and the appended claims.

What is claimed is:

1. A tack cloth comprising:
a woven fabric impregnated with resin, wherein at least one edge of said woven fabric is serrated.

2. The tack cloth as set forth in claim 1, wherein said at least one edge of said woven fabric is serrated by pinking shears.

3. The tack cloth as set forth in claim 1, wherein said at least one edge of said woven fabric is serrated by pinking shears forming triangular serrations.

4. The tack cloth as set forth in claim 1, wherein said at least one edge of said woven fabric is serrated by pinking shears forming rectangular serrations.

5. The tack cloth as set forth in claim 1, wherein said at least one edge of said woven fabric is serrated by pinking shears forming circular serrations.

6. The tack cloth as set forth in claim 1, wherein said woven fabric includes cotton.

7. The tack cloth as set forth in claim 1, wherein said woven fabric includes polyester.

8. The tack cloth as set forth in claim 1, wherein said woven fabric includes a blend of polyester and cotton.

9. The tack cloth as set forth in claim 5, wherein said woven fabric includes a blend of at least fifty-five (55%) polyester.

10. The tack cloth as set forth in claim 1, wherein said woven fabric includes a blend of at least sixty-five (65%) polyester.

11. The tack cloth as set forth in claim 1, wherein said resin includes polybutene.

12. The tack cloth as set forth in claim 1, wherein said woven fabric includes cheese cloth.

13. A method for manufacturing tack cloth comprising:
weaving fibers into a textile fabric with a loom;
impregnating said textile fabric with a resin; and
cutting said resin impregnated textile fabric to create at least one serrated edge.

14. The method for manufacturing tack cloth as set forth in claim 13, wherein said step of impregnating said textile fabric with a resin includes dipping said textile fabric in a tank.

15. The method for manufacturing tack cloth as set forth in claim 13, wherein said resin includes polybutene.

16. The method for manufacturing tack cloth as set forth in claim 15, wherein said polybutene is heated to at least 300 degrees Fahrenheit.

17. The method for manufacturing tack cloth as set forth in claim 13, wherein said step of impregnating said textile fabric with a resin includes dipping said textile fabric in a tank and moving said textile fabric between at least two pinch rollers.

18. The method for manufacturing tack cloth as set forth in claim 13, wherein said step of impregnating said textile fabric with a resin includes dipping said textile fabric in a tank with at least one guide roller and moving said textile fabric between at least two pinch rollers.

19. The method for manufacturing tack cloth as set forth in claim 13, wherein said step of cutting said resin impregnated textile fabric includes utilizing shears.

20. The method for manufacturing tack cloth as set forth in claim 13, wherein said shears includes pinking shears.

21. The method for manufacturing tack cloth as set forth in claim 13, wherein said step of cutting said resin impregnated textile fabric includes utilizing pinking shears to create triangular serrations along at least one edge of said resin impregnated textile fabric.

22. A tack cloth formed in accordance with the proces of claim 13.
